(19) United States
(12) Patent Application Publication
(10) Pub. No.: US 2007/0097371 A1
(43) Pub. Date: May 3, 2007

(54) LASER SENSING APPARATUS AND METHOD

(76) Inventor: Chris Parker, Edmonton (CA)

Correspondence Address: THOMPSON LAMBERT LLP;c/o Berger & Altmann, 2711 JEFFERSON DAVIS HIGHWAY Suite 401A, Airport Plaza One, ARLINGTON, VA, 22202, US

(21) Appl. No.: 11/458,797

(22) Filed: Jul. 20, 2006

Related U.S. Application Data
(60) Provisional application No. 60/700,816, filed on Jul. 20, 2005.

(51) Int. Cl. G01N 21/35

(52) U.S. Cl. 356/437; 250/343

(57) ABSTRACT

An apparatus for eliminating speckle noise from retro reflectors. A polyethylene film is introduced in an optical path between a retro reflector and a radiation receiver to reduce coherence length of collected light and eliminate sparkle noise.

### CROSS-REFERENCE TO RELATED APPLICATIONS

This application claims the benefit under 35 USC 119(e) of provisional U.S. application No. 60/700,816 filed Jul. 20, 2005.

### BACKGROUND

Tunable laser spectroscopy is commonly used for open path atmospheric trace gas sensing. In a typical system a laser beam from a gas sensing apparatus is projected from the apparatus through an open path containing the gas species under test. If the frequency of the laser is tuned to coincide with an absorption line of the gas, it will absorb some of the laser light and the light level detected by the apparatus will be reduced. If the laser frequency is tuned across the absorption line of the gas then the absorption spectrum of the gas may be determined. More relevantly, the average concentration of the gas in the optical path can be calculated by quantification of the gas absorption.

If the absorption of the gas under test is strong enough to dominate losses in the transmission of light along the path then it is straightforward to measure the absorption spectrum and calculate the average concentration of gas. However, if the absorption of the gas species under test is weak, as is usually the case, other mechanisms will dominate loss of light over the path and the determination of gas concentration is more complex. In practice there are many competing light loss mechanisms, including contamination of the optics, atmospheric turbulence, atmospheric absorption by gas species and atmospheric absorption and scattering by water and other atmospheric particulates. In order to isolate the effect of weak absorption by a gas species under test the laser wavelength is typically scanned several hundred times a second across the gas absorption line. If the scanning rate is faster than other light loss mechanisms such as atmospheric turbulence then the effects of gas absorption are easy to isolate. The laser diode is used for most practical tunable laser gas sensors. Laser diodes are small, self contained, low powered and relatively inexpensive and they may readily be tuned over the absorption lines of many gas species. One difficulty encountered with laser diode spectrometers is that the optical frequency is modulated by modulating the laser driving current but this current also modulates the light output of the laser. Small light level changes associated with gas absorption must consequently compete with the relatively large modulation of the laser output light level. Techniques referred to in the art as modulation spectroscopy are used to overcome this problem. In wavelength modulation spectroscopy for example the laser beam is modulated at high frequency as well as being scanned at lower frequency across an absorption line. Light that passes though the absorbing gas is detected by the instrument and the second or higher harmonic of the high frequency modulation is recorded. The amplitude of the modulation harmonics is proportional to the gas concentration if the gas absorption is weak. Amplitude modulation of the laser does not generate harmonics, at least to the first order, so using harmonics to detect gas is much more sensitive than using direct absorption.

Some tunable laser gas sensors are comprised of two components, a transmitter and a receiver. The transmitter generates and modulates a laser beam. The beam is then transmitted over a path of interest to a receiver. The receiver collects the incoming laser beam with either a mirror or lens and the beam is detected using a photodetector. The photodetector current then typically passes through a lock in amplifier tuned to the second harmonic of the laser modulation frequency. In alternative embodiment the transmitter and receiver are combined as a transceiver. The transmitter-receiver embodiment of the laser gas sensor has some significant disadvantages over the transceiver for long paths lengths and for portable use of tunable laser gas sensors. The transmitter and receiver must be connected by cable which can be cumbersome and expensive. Very small changes in transmitter pointing angle can cause large changes in the beam location at the receiver so that the transmitter-receiver tends to be mechanically unstable for long paths. On the other hand light from a transceiver may be reflected back by one or more retro reflectors at the far end of an open path without alignment of the retro reflector. This technique is much more mechanically stable for long path lengths.

The use of retro reflectors, however, brings with it optical noise problems. Retro reflectors are made up of an array of reflecting facets arranged so that a light wave impinging on the reflector will be reflected back along the incoming path. Commercial retro reflectors are imperfect and unlike the case of reflection from a plane mirror the wave front of a reflected laser beam is typically distorted. This distortion creates an interference patterns at the transceiver which change randomly because of atmospheric turbulence. Random interference patterns are referred to in the art as speckle. If several retro reflectors are used in an array the reflected waves from each of the reflectors interfere with each other at the transceiver which further adds to the complexity of the interference pattern. The speckle pattern at the transceiver changes with the laser optical frequency so that modulation of the laser frequency for gas detection also results in modulation of the speckle pattern. The resulting modulation signal competes with the gas signal and appears as a source of optical noise that limits the sensitivity of the instrument. Atmospheric propagation degrades the coherence of a laser but in practice speckle noise from retro reflectors is the sensitivity limiting effect for open path tunable laser gas sensors, even for the longest optical path lengths.

### SUMMARY

An apparatus and a new method of eliminating speckle noise from retro reflectors is introduced. In one embodiment, radiation is transmitted to a receiver via a retroreflector. An optical diffuser is used at least in the path between the receiver and retroreflector to degrade the coherence of the reflected beam from the retro reflector so that the coherence length of the beam at the receiver (which could be part of a transceiver) is reduced so that it is much less than the dimensions of the receiver optics. Atmospheric turbulence reduces speckle noise in a similar manner but the effects of the atmosphere on speckle noise are limited, depend upon path length and are unpredictable.

According to an aspect of the apparatus, there is provided a radiation sensor comprising a coherent radiation source, retro reflector and radiation receiver, the retro reflector being disposed in an optical path between the coherent radiation source and the radiation receiver, and a speckle reducing optical diffuser between the retro reflector and the radiation receiver. In other aspects or embodiments of the apparatus: the speckle reducing optical diffuser is selected to provide a desired amount of speckle reduction; the coherent radiation source may be a laser transmitter and the radiation receiver may be combined with the laser transmitter as a transceiver; the speckle reducing optical diffuser may be a film, and may be one or more polyethylene films, which may be stacked together; the speckle reducing optical diffuser may be provided only between the retro reflector and receiver and not between the transmitter and retro reflector. If a large window is provided for optical access to a transceiver, and the film covers the window, an opening in the film may be provided to prevent attenuation of the outgoing laser beam.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 shows an arrangement of windows lying on an open path between a laser gas sensor and one or more retro reflectors.

FIG. 2 shows an alternate arrangement of windows lying on an open path between a laser gas sensor and one or more retro reflectors.

### DETAILED DESCRIPTION

In one embodiment, an apparatus comprises a coherent radiation source, a radiation receiver, a retro reflector disposed in an optical path between the coherent radiation source and the radiation receiver; and a speckle reducing optical diffuser disposed in an optical path between the retro reflector and the radiation receiver. In practice, the transmitter and receiver will usually be combined as a transceiver. Also, in practice, the transmitter will typically be a laser diode operating in the infrared part of the spectrum.

The optical diffuser has optical imperfections or facets that interact with the radiation passing through the optical diffuser to reduce the coherence length of the radiation and reduce the speckle at the receiver. The imperfections or facets typically have a random pattern, and dimensions larger than the wavelength of the radiation, so as to affect the radiation, but not so large that the radiation is dispersed so far beyond the dimensions of the receiver that insufficient radiation reaches the receiver for practical use. That is, the coherence length of the radiation that has passed through the optical diffuser should be less than the receiver aperture. An example of an optical diffuser is a simple readily available polyethylene film, which is optically imperfect, and is introduced into the optical path between the transceiver and the retro reflector. A polyethylene type of film is characterized by a rough surface and optical density variations which give the film a milky opacity in the visible part of the spectrum. A polyethylene type of film will transmit the near infrared light used for laser gas sensing. Since the effects of optical inhomogeneities depend upon optical wavelength this type of film is optically clearer in the near infrared part of the spectrum than in the visible. A polyethylene optically diffusing film when introduced between the transceiver and retro reflector can reduce the coherence length of collected light and eliminate speckle noise. A polyethylene type of film can be used to eliminate speckle noise without unacceptable reduction of light reflected back to the transceiver. Various thicknesses of polyethylene film are readily available varying typically from 0.01 mm to 0.1 mm. Thinner film is less optically homogenous and hence more opaque than thicker film.

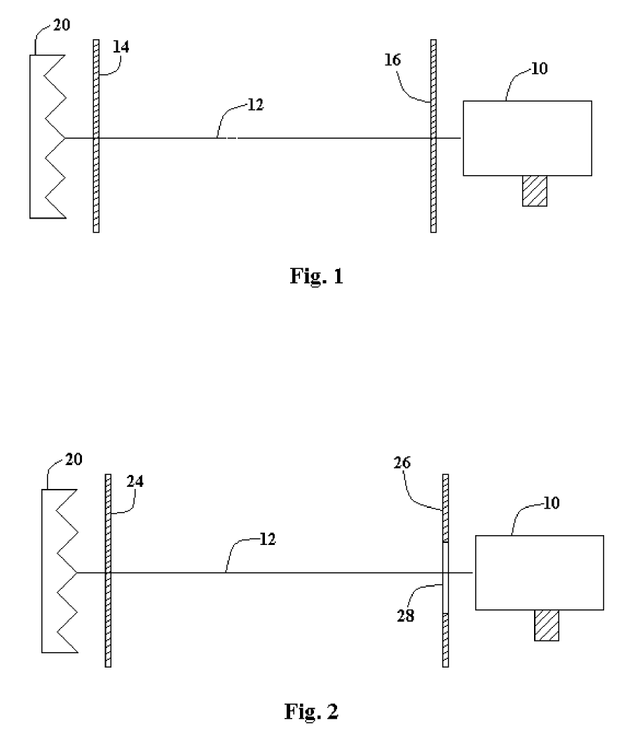

Although many types of optically inhomogeneous element may be used to reduce speckle noise in a laser gas sensor the following embodiments are shown in FIGS. 1 and 2. Examples of optical diffusers include various transparent films or plates, for example made of plastics, polycarbonate and glass, that have roughened surfaces or other characteristics, such as internal characteristics, that provide optical inhomogeneities.

In FIG. 1, a laser gas sensor 10, for example a Boreal Laser GasFinder™, is aligned along an open path 12 and laser light is reflected back to the laser gas sensor by one or more retro reflectors 20. Windows 14 and 16 cover the optical elements in the transceiver and the retro reflectors. Either or both windows may be an optically diffusing film to reduce speckle noise. In a preferred embodiment the window 14 covering the retro reflectors is a diffusing film and window 16 is an optically clear window. The choice of film that will eliminate speckle noise without unacceptable optical attenuation depends upon path length. As an example, a diffusing film window 14 of 0.1 mm thickness may be used with a six element array of 4 cm retro reflectors for path lengths of up to 500 m for a laser wavelength of 1500 nm. In another example a diffusing film window 14 of 0.01 mm thickness with a six element array of retro reflectors may be used for a path length of 100 m. For shorter paths two or more diffusing films may be used for window 14. Those skilled in the art could readily choose a suitable diffusing film window 14 for any range of path length.

FIG. 2 shows another embodiment where the window 26 is diffusing film and window 24 is a clear window. The effect of a diffusing film window 26 on speckle noise is less than the effect of the clear window 24 on speckle noise. More optical inhomogeneity is needed to eliminate speckle so typically two or more diffusing films in a stack are used for window 26. This window 26 strongly attenuates the outgoing laser beam without associated speckle reduction since much less light propagates to the reflector. In this case a small aperture 28 in window 26 is preferred to avoid attenuation of the outgoing beam.

In the claims, the word “comprising” is used in its inclusive sense and does not exclude other elements being present. The indefinite article “a” before a claim feature does not exclude more than one of the feature being present.

Immaterial modifications may be made to the embodiments described here without departing from what is covered by the claims.

What is claimed is:

1. An apparatus comprising:
a coherent radiation source;
a radiation receiver;
a retro reflector disposed in an optical path between the coherent radiation source and the radiation receiver; and
a speckle reducing optical diffuser disposed in an optical path between the retro reflector and the radiation receiver.

2. The apparatus of claim 1 in which the coherent radiation source is a laser transmitter.

3. The apparatus of claim 2 in which the radiation receiver is combined with the laser transmitter to be a transceiver.

4. The apparatus of claim 1 in which the speckle reducing optical diffuser comprises one or more polyethylene films.

5. The apparatus of claim 1 in which the speckle reducing optical diffuser does not lie in an optical path between the transmitter and the retro reflector.

6. The apparatus of claim 3 in which:
a window is provided for optical access to the transceiver;
a polyethylene film covers the window;
an opening in the polyethylene film is provided so that there is an optical path between the laser transmitter and the retro reflector that does not pass through the polyethylene film but the optical path between the retro reflector and the radiation receiver passes through the polyethylene film.

7. A method of eliminating speckle noise from retro reflectors, comprising:
transmitting radiation from a coherent radiation source to a radiation receiver via a reflector that introduces speckle noise in the radiation; and
reducing speckle noise in the radiation received at the radiation receiver by placing a speckle reducing optical diffuser between the reflector and the radiation receiver.

8. The method of claim 7 in which the speckle reducing optical diffuser comprises one or more polyethylene films.
